(19) United States
(12) Patent Application Publication
(10) Pub. No.: US 2007/0035762 A1
(43) Pub. Date: Feb. 15, 2007

(54) System and method for multiparty payment for print jobs

(75) Inventors: Mike Wilsher, Hertfordshire (GB); Richard Gillam, Hertfordshire (GB); Ian Burdon, Hertfordshire (GB)

Correspondence Address: CARTER, DELUCA, FARRELL & SCHMIDT, LLP, 445 BROAD HOLLOW ROAD, SUITE 225, MELVILLE, NY, 11747, US

(73) Assignee: Xerox Corporation, Stamford, CT (US)

(21) Appl. No.: 11/583,244

(22) Filed: Oct. 19, 2006

Related U.S. Application Data
(63) Continuation-in-part of application No. 10/244,574, filed on Sep. 16, 2002.

(51) Int. Cl. G06K 15/00

(52) U.S. Cl. 358/1.14; 358/1.15

(57) ABSTRACT

A system for effecting payment for a print job includes a mobile device interfacing contactlessly with a document machine having a print engine, and a processor in communication with the mobile device. The processor is configured to authorize a print job and effect payment for the print job. A method of effecting payment for a print job includes the step of interfacing contactlessly with a document machine via a mobile device. The method may include receiving a print job via the mobile device, verifying at least one of the identity of the user and the validity of a payment vehicle. If at least one of the identification is verified and the payment vehicle is validated, the method includes authorizing the print job, performing the print job, and deducting payment via a payment processor in accordance with at least one parameter of the print job.

### CROSS-REFERENCE TO RELATED APPLICATION

This application is a continuation-in-part of U.S. patent application Ser. No. 10/244,574 filed on Sep. 16, 2002 by Gillam et al. entitled “PORTABLE INPUT SCANNING DEVICE IN COMMUNICATION WITH A MULTI-FUNCTION DOCUMENT SERVICES MACHINE”.

### TECHNICAL FIELD

The present disclosure relates to the field of transaction data systems, and more particularly, to transaction data systems interfacing with various mobile devices.

### BACKGROUND

Recently “multi-function” office equipment has become familiar in offices. Whereas, previously, functions such as copying, printing, and facsimile transmission have been performed by single dedicated copiers, printers, and facsimiles respectively, a multi-function machine is typically capable of providing all such functions and more in a single machine. Typically such a multi-function machine includes a single print engine, which can serve to output copies, prints, or received facsimiles; as well as a single input scanner which can serve to record data from original images for use in copying, facsimile transmission, and retention of input image data to a predetermined location in a computer memory (“scan-to-file”). Such multi-function machines are typically connected to data networks, such as the Internet, for exchange of both image data and associated operational instructions. Also, such machines, particularly those including high-speed printing engines, tend to be large and heavy.

In addition, applications of multi-function document (MFD) machines commonly occur where a financial transaction between a prospective user of the MFD machine and an operator or proprietor of the MFD machine must be completed before processing a print job request for the user.

### DESCRIPTION OF THE PRIOR ART

One type of input scanner records image data from a non-flat original, such as an open book. A head having photosensors therein is moved manually over the original.

Another type of image scanner is hand-held image scanner in which a photosensor array is manually moved relative to an image to be scanned. The device includes an on-board memory and editing device, including editing keys.

Yet another image data recording and filing apparatus includes a portion, including photosensors, for recording images, and a portion including a memory for retaining image data and also entering, through a small keyboard, data by which data which is recorded at a particular time can be later identified.

Another hand-held device records original images, such as from business cards, and retaining and displaying such images as desired. The device includes an encoding roll for coordinating the motion of the recording device with incoming image data when the device is manually rolled against the image to be recorded.

One compact input scanning device uses ambient light as a light source. The scanner can be used as a facsimile device by providing telephone connections.

Still another hand-held device can function both as a computer pointing device, or mouse, and as a scanner from recording images such as from printed books.

In an electronic camera system, the position of an electronic camera relative to a document can be recorded and used to enhance document-intensive functions such as copying.

In a system for accessing and distributing electronic documents, a hard-wired network including multi-function machines further includes a set of personal, hand-held IR-based devices. Users, each having an IR-based device, transmit tokens symbolic of documents available within the network.

In an architecture for office equipment, such as a multi-function machine, separate modules, such as the paper supply, input scanner, and finisher communicate with a central control system through wireless means.

An open network system supports input/output (I/O) operations for non-standard I/O devices, which include magnetic stripe readers, check readers, smart card readers, credit card terminals, screen phone terminals, PIN pads, printers and the like.

### SUMMARY

In addition to downloading a print job to a document machine such as a multi-function printer, the present disclosure relates to a system and a method for paying for for the print job using a mobile device such as a cellular telephone or a personal digital assistant (PDA).

The present disclosure is directed to systems by which input scanning of original images, such as from a device which reads images from hard-copy documents, or a digital camera, can be performed remotely from a multi-function machine. The multi-function machine, which can include more typical office functions such as copying and printing from desktop computers, accepts the image data and then performs desired functions thereon.

The present disclosure relates also to a system and method for multiparty payment for print jobs. More particularly, the present disclosure relates to a system for effecting payment for a print job that includes a mobile device interfacing contactlessly with a document machine having a print engine, and a processor in communication with the mobile device. The processor is configured to authorize a print job and effect payment for the print job. The processor may be disposed at a remote central station interfacing with the document machine and the remote central station may be configured to effect payment via a network in communication with the document machine and with the processor. The mobile device may communicate with the remote central station via an external processor. The external processor and the processor may be in communication with the mobile device communicating therebetween to authorize the print job and effect payment for the print job.

The document machine may further include a control board and an interface module in communication with the control board. The interface module may be configured to interface with the mobile device to download at least one of a user identification and a payment vehicle to the control board for at least one of authorizing a print job and effecting the payment for the print job. The interface module may be configured to contactlessly interface with the mobile device to enable downloading of the print job to the control board. The processor may be disposed at a remote central station interfacing with the document machine. The remote central station may be configured to authorize the print job and to effect payment of the print job via a network in communication with the mobile device and with the processor.

In one embodiment, the document machine may further include a control board; and an interface module in communication with the control board, wherein the interface module is configured to contactlessly interface with the mobile device to enable authorizing downloading a print job to the control board. -The interface module may enable downloading a print job from the mobile device.

The mobile device may be selected from the group consisting of a telephone, a personal digital assistant (PDA), a digital camera, an electronic microscope, a CAT scanner, an X-ray camera, a security camera, a badge reader, a biometric reader, a currency reader, a counterfeit detector, and a diagnostic machine that outputs graphs.

The present disclosure relates also to a remote central station for payment of a print job. The remote central station includes means for communicating via a network with at least one mobile device and a document machine having a print engine, a customer database storing a plurality of customer records, each customer record identified by a user identification, a processor for receiving at least one user identification via the means for communicating and accessing a customer record for identifying a payment vehicle corresponding to the received user identification, and means for communicating with a payment processor for transmitting payment authorization thereto for effecting payment using the identified payment vehicle. The remote central station processor may receive payment from the payment processor and deducts at least a portion of the payment and directs the at least a portion of the payment to a system proprietor account and transmits the remaining portion to at least one external account.

The present disclosure relates also to a method of effecting payment for a print job that includes the step of interfacing contactlessly with a document machine via a mobile device. The method may further include the steps of: receiving a print job via the mobile device; verifying at least one of the identity of the user and the validity of a payment vehicle, and wherein if at least one of the identification is verified and the payment vehicle is validated, authorizing the print job; performing the print job; and deducting payment via a payment processor in accordance with at least one parameter of the print job. The method may further include the steps of: receiving the payment to a system proprietor account from the payment processor; and deducting from the payment a fee for the system proprietor. The method may further include the step of transferring the balance of the payment to at least one other account. The user identity may be verified by accessing a plurality of records in a customer database.

### BRIEF DESCRIPTION OF THE DRAWINGS

FIG. 1 is a diagram showing the interaction among various multi-function document machines, such as printer-copier-fax-scanners, and image input devices;

FIG. 2 is a picture of an example image input device;

FIG. 3 is a simplified diagram of a basic multi-function machine, in combination with an interface module according to an embodiment of the present disclosure;

FIG. 4 is a simplified diagram of a portion of a system for effecting payment for a print job according to another embodiment of the present disclosure;

FIG. 5 is an illustration of a cellular or mobile telephone serving as a mobile device according to the embodiment of FIG. 4;

FIG. 6 is a simplified diagram of another portion of the system for effecting payment for a print job according to the embodiment of the present disclosure illustrated in FIG. 4;

FIG. 7 is a simplified diagram of a portion of a system for effecting payment for a print job according still another embodiment of the present disclosure;

FIG. 8 is a simplified diagram of another portion of the system for effecting payment for a print job according to the embodiment of the present disclosure illustrated in FIG. 7;

FIG. 9 is a flow chart for a method of authorizing a print job and effecting payment of the print job according to the present disclosure; and

FIG. 10 is a continuation of the flow chart for a method of authorizing a print job and effecting payment of the print job of FIG. 9.

### DETAILED DESCRIPTION

The following terms are used in the detailed description below. The terms may be described again in greater or lesser detail in subsequent portions of the detailed description and with respect to the specific embodiments of the present disclosure:

A multi-function document machine or machines refers to machines such as printer-copier-fax-scanners (hereinafter “machines” or “MFD machines”)

Image input devices or mobile devices (hereinafter “devices”) refer to devices that are a source of image data and instructions, and include, but are not limited to, cellular phones, personal digital assistants (PDA), digital cameras, or combinations thereof, and that include capability for contactless communication with an external device or a network, such as by phone or text messaging.

Image and instructional data refers to data that must be processed, such as by printing/copying, faxing, or filing the data, in accordance with the instructions sent from a particular image input device or mobile device.

A recorder or mobile device refers to a device that records an image, either from markings, such as writing on a handwritten or printed document, or directly from reality, such as in a case where a physician photographs a patient or an insurance person photographs an automobile. The recorder can take any of a variety of forms depending on a desired task, such as: a mobile or cellular telephone having image capture capability, a digital camera, an electronic microscope, a CAT scanner, X-ray camera, or other medical device; a security camera; a badge reader; a fingerprint, retina, or other biometric reader; a currency reader or counterfeit detector; a medical or other diagnostic machine that outputs graphs, etc.

Instruction pad which may include keys or alternate devices such as a stylus-based pointing system, refers to a means by which a human user can associate some recorded image data with an instruction for a machine as well as some identification data.

Transceiver refers to an apparatus, in the form of circuitry, software, etc. that may be enclosed within a casing, that typically includes both a transmitter and receiver, for conveying image data from a recorder and instructional and other data from an instruction pad to a MFD machine. The transceiver can receive “handshake” and other data from a control system associated with a machine, in order to carry out the transmission of data.

Wireless mode of communication refers to modes of communication such as infrared (IR) or radiofrequency (RF) modes of communication between a device and/or a machine. As used herein, contactless mode of communication and wireless mode of communication are used interchangeably. As used herein, the terms “contactless” and “contactlessly” refer to means and methods of communication not requiring a material, e.g., a hard-wired, connection. Infrared light and radiofrequency waves are also examples of contactless communication.

Network refers to a system of computers, peripherals, terminals, and databases connected by communications lines. The communications lines may be hard-wired conduits including optical communications lines or wireless or contactless modes of communication as defined above.

Print engine refers to hardware and associated software that accepts image data, in any data format (such as, but not limited to, PDL, PCL, TIFF, ASCII, JPEG), relating to images desired to be printed, and outputs prints bearing images derived from the input image data. The print engine may have associated therewith one or more interpreter programs, and associated hardware, for converting the submitted image data from an original data format to a format more directly operative of printing hardware, such as a modulating laser or ink-jet printhead.

Central control board refers to electronic circuitry and/or software having the function of managing flows of image data and control data within a multi-function document (MFD) machine. The control board can include memory elements, drives, a general-purpose CPU, data processing software, etc., and various elements of the control board can reside in the machine or on computers, mobile devices, etc. external to the MFD machine.

Job Queue refers to any combination of software and hardware which includes or controls a memory for retaining image and/or instructional data relating to jobs which are waiting to be printed, copied, faxed, sent to external memory in a computer or otherwise processed by a machine.

Print job refers to a hard copy printer output of papers, documents, drawings, photographic images and the like. A print job also includes a scan-to-file, a facsimile, an email or a scan to email throughput.

Walk-up job refers to a print or copy job in which instructions for printing are submitted by a human user to a user interface physically close to the print engine. The walk-up job can also include submission of image data to be printed, such as a hard-copy for copying, or image data on CD (compact disk), floppy disk, USB (universal serial bus) stick, or other suitable technology. A walk-up job is the default setting for a print job or copyjob.

A user interface (UI) includes one or more hard keys and a touchscreen or similar dynamic interface.

An input scanner refers to a device for scanning image data from hard-copy originals.

An interface module refers to one or more devices configured to act as a bridge between one or more image input devices or mobile devices. The interface module may be installed on or is otherwise associated with one or more multi-function document machines. The interface module may reside on a personal computer communicating with a multi-function document machine, or installed on a PC board in a multi-function document machine. The interface module can have a network address independent of that of the multi-function document machine.

A remote central station refers to a CPU that includes communication circuitry for communicating via a network with at least one mobile device and an MFD machine. The remote central station may refer also to a personal computer (PC) that is coupled to a network. The remote central station includes a customer database storing a plurality of customer records for a plurality of registered users or customers. Each customer record may be identified by user identification data such as a customer ID, a password or a combination thereof.

A first type of payment vehicle refers to a physical entity, for example, a contactless device such as an RFID (radiofrequency identification) tag or label having a self-contained transponder or transmitter or a smart card (e.g., a contactless card containing machine readable financial data, such as smart cards in “Osaifu-Keitai” mobile phones in use currently in countries such as Japan) , an IrDA port, and/or code symbology such as a bar code displayed on a screen of a mobile device. The payment vehicle stores machine readable data representing a financial account having an account number with which funds are associated with respect to a user identification for one or more individuals or organizations. The financial account may be a credit account that may have a credit card associated therewith or a financial account associated with a debit card associated therewith, such as a checking account or other similar financial institution account.

A second type of payment vehicle may refer to electronic data stored in an external processor or in another processor in, or in a data base in, direct communication with the external processor. The payment vehicle may be a telecommunications account stored and managed by the external processor. The payment vehicle may represent a financial account having an account number with which funds are associated with respect to a user identification for one or more individuals or organizations. In a similar manner to the first type of payment vehicle, the second type of payment vehicle may represent a credit card account, a debit card account, or an electronic deposit account for which funds are pre-paid, e.g., Pay-Pal™. User identification data may be included with the data associated with the second type of payment vehicle or the user identification data may be stored in a separate electronic data file associated with the financial account.

Mobile device refers to an electronic device having telecommunications capability such as a cellular or mobile telephone that includes an instruction pad for entering alphanumeric data, e.g., text messaging, telephonic data and the like, for “contactless” telecommunications via a transceiver. The electronic device may also include features designated for payment input and authorization functions. The mobile device includes electronic devices having telecommunications capability such as mobile or cellular telephone, a personal digital assistant (PDA) that has an instruction pad and a transceiver. The mobile device may include an electronic device having both telecommunications capability and also image capture/recording capability such as a mobile or cellular telephone having photographic image capture capability, an electronic microscope, a CAT scanner, X-ray camera, or other medical device; a security camera; a badge reader; a fingerprint, retina, or other biometric reader; a currency reader or counterfeit detector; a medical or other diagnostic machine that outputs graphs, etc.

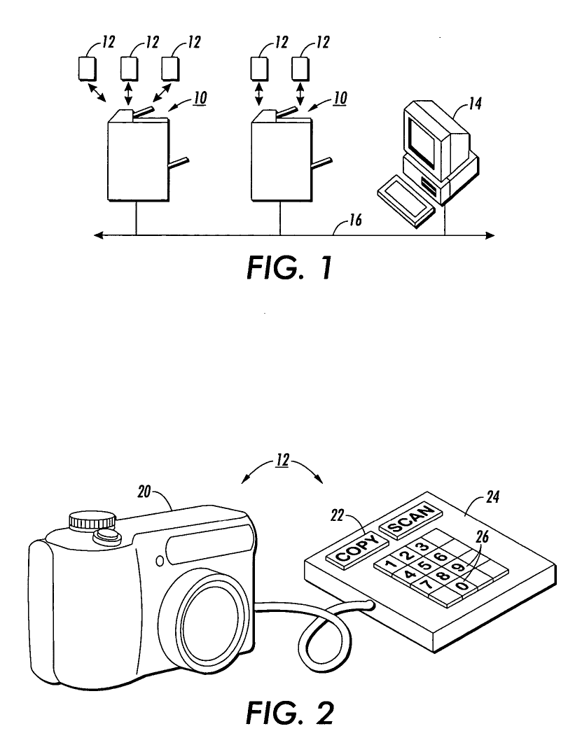

FIG. 1 is a diagram showing the interaction among various multi-function document machines such as printer-copier-fax-scanners (hereinafter “machines” 10) and image input devices or mobile devices (hereinafter “devices” 12) such as, but not limited to, cellular phones, personal digital assistants (PDA), digital cameras, or combinations thereof, and that include capability for contactless communication with an external device or a network, such as by phone or text messaging, according to one embodiment of the present disclosure. Each machine 10 includes functions, embodied in hardware and software, for printing images on sheets, as well as accepting image data through a hard-copy input scanner; when an image is recorded with the input scanner and subsequently printed, the machine 10 acts as a copier. Further document related functions, such as facsimile transmission and reception, as well as sending data from scanned images to predetermined locations in the memory of an external computer such as 14 through a network 16, are also known. In one embodiment, each machine 10 is of a basic known type, and the functions relating to the disclosure are embodied in hardware and software which may be ported to a machine such as 10.

For one machine 10 or each of a plurality of machines 10 on a network 16, each device 12 is adapted for communication of image and instructional data to the machine 10; each machine 10 treats such data substantially as any other type of data that must be processed, such as by printing/copying, faxing, or filing the data, in accordance with the instructions sent from a particular device 12. In short, each device 12 represents a source of image data and instructions for a selected machine 10, alongside other, more standard sources of data and instructions associated with the machine, such as for printing or copying documents.

FIG. 2 is a picture of an example device 12. Each device 12 includes at least three elements, a recorder 20, an instruction pad 22, and a transceiver 24 (which would be in the form of circuitry, software, etc. within the casing shown). In the illustrated embodiment, recorder 20 is in the form of a digital camera, which once again can be of a basic type currently available on the market, although more specialized types of recorders may be envisioned, as will be explained below. The function of recorder 20 is to record an image, either from markings, such as writing on a handwritten or printed document, or directly from reality, such as in a case where a physician photographs a patient or an insurance person photographs an automobile.

Although a digital camera of common configuration is shown in FIG. 2 as recorder 20, the recorder can take any of a variety of forms depending on a desired task, such as: a mobile or cellular telephone having photographic image capture capability, an electronic microscope, a CAT scanner, X-ray camera, or other medical device; a security camera; a badge reader; a fingerprint, retina, or other biometric reader; a currency reader or counterfeit detector; a medical or other diagnostic machine that outputs graphs, etc.

Instruction pad 22, which may include keys 26, as shown, or alternate devices such as a stylus-based pointing system, is a means by which a human user can associate some recorded image data with an instruction for a machine 10 as well as some identification data, as will be explained below. Transceiver 24, which in a practical embodiment typically includes both a transmitter and receiver, is an apparatus for conveying image data from recorder 20 and instructional and other data from instruction pad 22 to a machine 10; also, as needed for a typical implementation, the transceiver can receive “handshake” and other data from a control system associated with a machine 10, in order to carry out the transmission of data. In the embodiment, a contactless or wireless (e.g., infrared (IR) or radiofrequency (RF)) mode of communication between a device 12 and machine 14 is contemplated; however, any means of communication, including a cable from a device 12 to a machine 10 such as through a universal serial bus (USB) port, can be envisioned. Also, commercial mobile or cellular phone technology, suitably adapted, can be used for the transmission from the device 12 to the machine 10. When the recorder 20 is a mobile or cellular telephone, the instruction pad 22 and the transceiver 24 may be integrated with the mobile or cellular phone.

In operation, a user records image data with recorder 20 and also uses the instruction pad 22 to communicate a command, that is, what the user wishes to do with the data (typically, the user can give the command either just before or just after recording the data, e.g. taking the picture). In one case, the user touches the “copy” key: in this case, the image data from the recorded picture is transmitted through transceiver 24 to a selected machine 10. Devices 12 can be associated with individual machines 10, or, conceivably, a device 12 can in effect broadcast instructions and image data, such as through a factory or medical office, and a closest or otherwise most suitable machine 10 can accept the data and instruct other machines to ignore the data. The image data is received at the machine 10, and the machine 10 places the image data, and in response to the command from device 12, places the image data in its job queue, along with any other print or copy jobs that may have come from other sources, such as hard-wired personal computers or the machine's own local image scanner. In one embodiment, the job originating from a device 12 is treated indistinguishably from any other job handled by the machine 10. In effect, the device 12 acts as an auxiliary input scanner and user interface for the machine 10.

In a scan-to-file case, a user touches a key on instruction pad 22, and in response the transceiver 24 sends the image data and command to machine 10. The machine 10 in turn directs the image data to a predetermined location in memory, such as in computer 14. The predetermined location can be established in various ways, such as by the identification of the source device 12 and/or the time of transmission. Alternately or in addition, each human user having a device 12 can enter an account number, such as a patient number in the medical context, or a file number in the insurance context: the identification number is used when directing the image data to a file (already associated with the patient, policy number, etc.) in the external computer 14 so that it can be retrieved as desired later. Entry of such identification data is made through a numeric keyboard on the pad 22, or through a stylus-based pointing system, or by having the user first scan a barcode or equivalent with recorder 20, which causes all subsequent recorded images to be associated with the bar code, until a new barcode is scanned.

In a facsimile case, a user holding the device 12 can enter a fax number into the instruction pad 22 (either the destination fax number itself, or some key which is in effect a “fast-dial” key for a desired number), such number (or other code relating to the destination fax number) then being transmitted to a machine 10 along with the recorded image. When the machine 10 receives the image data and the fax number, the data is retained in a job queue, along with any other jobs associated with the machine 10 at the time. When the job reaches the front of the queue, the machine 10 initiates the fax transmission.

In the multi-function machine context, a machine 10 in effect maintains one or more queues of various jobs, such as print, copy, fax send and receive, and scan jobs. In one embodiment, image data and associated instructions from one or more devices 12 are simply entered into one or another appropriate queue within the control system alongside other jobs which are entered into the machine 10 in traditional ways. In this way, the large-scale efficiencies resulting from the shared resources within a multi-function machine are preserved in an office or library context.

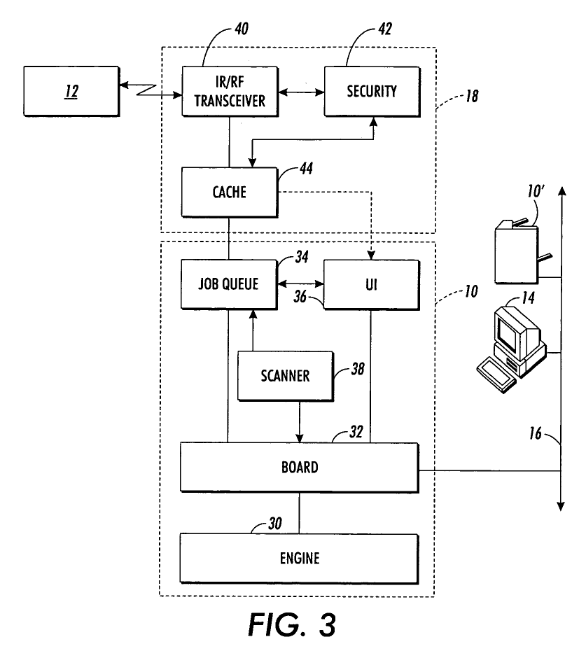

FIG. 3 is a simplified diagram of a basic copier-printer-facsimile—scanner machine 10 as would be modified according to an embodiment of the present disclosure. The basic machine 10, which can be an “off the shelf” product of pre-existing design, includes a print engine 30, which is directly controlled by software and hardware in a central control board 32, as is familiar in the art. Feeding into the board 32 is a job queue 34. As used herein, the term “job queue” refers to any combination of software and hardware which includes or controls a memory for retaining image and/or instructional data relating to jobs which are waiting to be printed, copied, faxed, sent to external memory in a computer such as 14, or otherwise processed by the machine.

For “walk-up” jobs, a standard multi-function document machine such as 10 includes a user interface (UI) 36, which typically includes one or more hard keys and a touchscreen or similar dynamic interface; related to UI 36 would be the software operative on various client computers, such as for sending print jobs to the queue 34. As used herein, in addition to being a hard copy printer output of papers, documents, drawings, photographic images and the like, a print job includes a scan-to-file, a facsimile, or an email throughput. The machine 10 further includes an input scanner 38, as is familiar in the art, for scanning image data from hard-copy originals; the resulting image data is queued in job queue 34 for processing according to instructions entered on UI 36.

According to this embodiment, augmenting the basic machine 10 is what is here called an “interface module” 18, which is installed on or otherwise associated with one or more machines 10; the module 18 could, for example, reside on a personal computer communicating with machine 10, or installed on a board in machine 10. Also, the module 18 can have a network address independent of that of the machine 10. Interface module 18 acts as a bridge between one or more devices 12 and the basic machine 10. As such, module 18 includes a transceiver 40, typically of an IR or RF variety, which accepts signals from one or more devices 12 within range. There may also be provided a security arrangement 42 to restrict wireless or other access to the module 18 to authorized devices 12, such as by checking for an identification code with incoming signals. Information obtained through the operation of the security arrangement 42 can also be associated with the incoming image data, such as by a determined identity of the sending device 12, and/or a time stamp of the incoming data. The time-stamp or the identity of the sending device can further be associated, within the interface module 18, with a destination location in memory of a computer 14, in a manner such as generally described above.

Once communication is established between a device 12 and module 18, image data along with associated instructions (copy, scan-to-file, fax, etc.) are briefly retained in a cache memory 44; at a suitable time, the image data from a device 12 is handed over to the job queue 34 of the basic machine, and the associated instruction is handed over to the UI 36. After this point, the job received from the device 12 is in effect received alongside job data in job queue 34 of machine 10, such as regular print jobs from computers on the network, and scan or copy jobs from the regular scanner 38.

Features within an interface module 18 (or elsewhere, depending on the embodiment) can further be provided to facilitate an environment having multiple devices 12 and machines 10. For instance, if there are provided multiple machines 10, each of which is likely to receive a wireless signal from a particular device 12, an arrangement can be made whereby a “preferred” machine is programmed to perform the desired processing, such as printing or scanning, depending on the identity of the sending device 12; e.g., a doctor in an examining room may wish to have the pictures printed by the machine in his personal office within a large clinic. Other machines which may receive the same signal can be instructed not to process the image data; however, the other machines can be programmed to cache the received image data, such as in their respective cache memories 44, for a certain time or until certain conditions are met, such as the “preferred” machine 10 successfully processing the image data and in effect instructing other machines, such as on network 16 in FIG. 1, that they can overwrite the image data. Such an arrangement further facilitates a back-up system, whereby multiple machines 10 receive the data from a device 12, but only the preferred machine 10 is caused to process the image data; however, if after some amount of time the preferred machine 10 is determined to be somehow “down,” a second machine (here shown as 10′ in FIG. 3) on the network 16 is in effect instructed to process the image data cached therein, either by an explicit instruction from the preferred machine 10, or by implication, such as if a confirmation of successful processing is not received from the preferred machine.

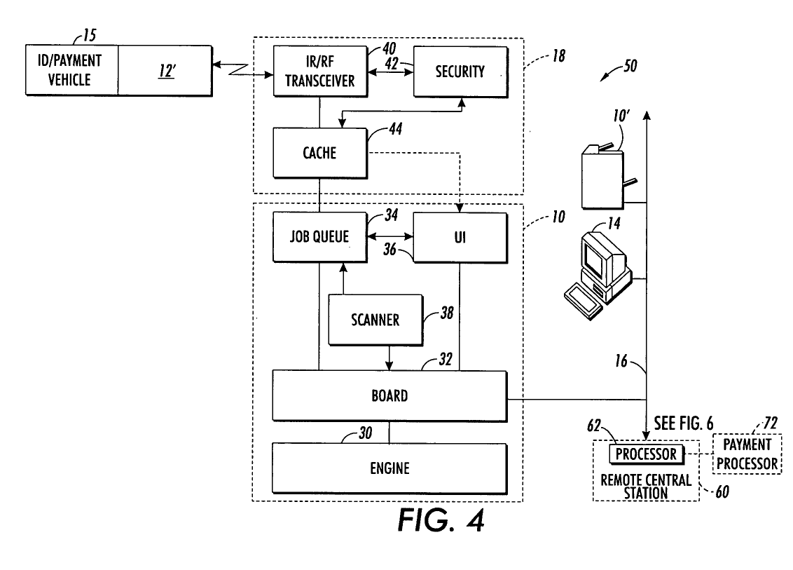

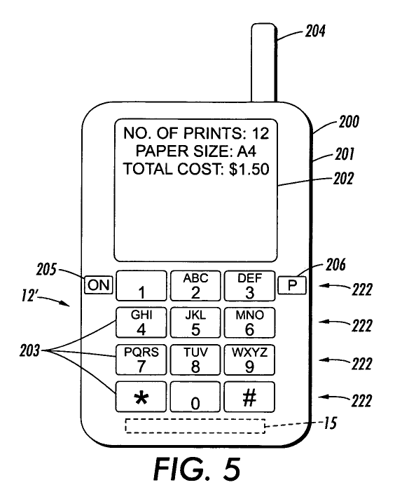

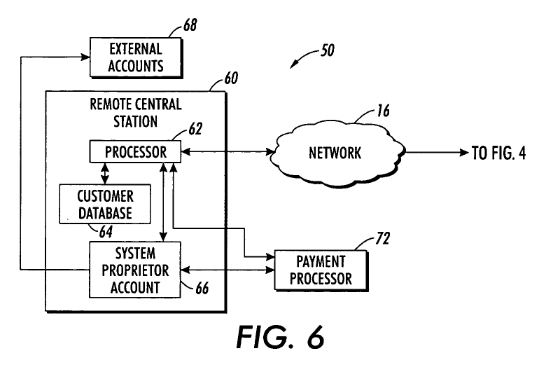

Referring to FIGS. 4-6, there is illustrated a system for effecting payment for a print job according to the present disclosure. More particularly, system 50 includes a mobile device 12′ that interfaces contactlessly with the document machine 10 or 10′. Mobile device 12′ differs from mobile device 12 described above in that mobile device 12′ does not necessarily require a recorder 20, i.e., image capture capability, but does require an instruction pad, which is illustrated in the example of a mobile or cellular telephone 200 in FIG. 5 as instruction pad 222, and a transceiver, and is discussed in more detail below.

As described above, the document machine 10 (or 10′) has a print engine 30. In addition to the mobile device 12 , the interface module 18 and the document machine 10, the system 50 further includes a processor 62 in communication with the mobile device 12′. As illustrated in FIGS. 4-6, the processor 62 communicates with the mobile device 12′ indirectly via the network 16 through the central control board 32 of the document machine 10 and through the interface module 18. The processor 62 is configured to authorize a print job and effect payment of the print job.

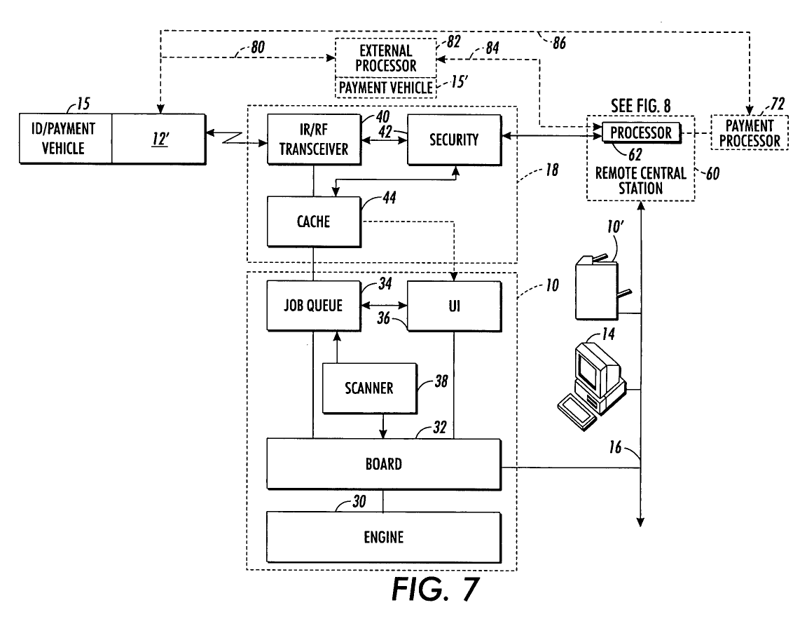

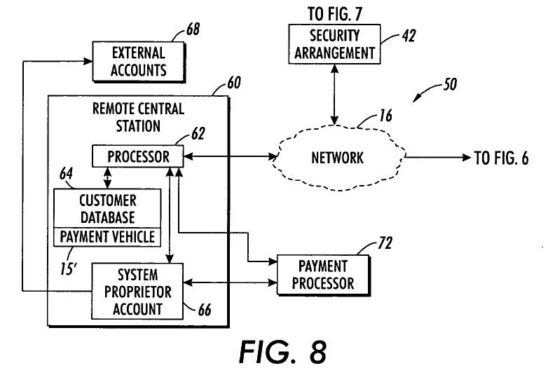

The processor 62 may be disposed at a remote central station 60 that interfaces with the document machine 10 (or 10′) through the central control board 32. The remote central station 60 is configured to authorize the print job and to effect payment of the print job via the network 16 that is in communication with the document machine 10 (or 10′) and with the processor 62. The remote central station 60 includes communication circuitry for communicating via the network 16 with the at least one mobile device 12′ and the document machine 10 (or 10′) having print engine 30. Included in the remote central station 60 is a customer database 64 (see FIG. 6) storing a plurality of customer records for a plurality of registered users or customers. Each customer record is identified by user identification data such as a customer ID, a password or a combination thereof.

The processor 62 receives user identification via the network 16, and accesses a customer record corresponding to the received user identification. The customer record is used by the processor 62 for identifying a payment vehicle corresponding to a pre-registered customer associated with the received user identification. The remote central station 60 communicates with a payment processor 72 and authorizes the payment processor 72 to effect payment using the identified payment vehicle.

A user identification and/or a payment vehicle 15 may be adjacent to the mobile device 112, as illustrated in FIG. 4, or reside in the mobile device 12′, as illustrated in FIG. 5, to enable the contactless communication between the mobile device 12′ and the interface module 18 via the IR/RF transceiver 40, as explained above, or other device, such as a bar code reader, in communication with the document machine 10. FIG. 5 illustrates an example wherein the mobile device 12′ is a cellular or mobile telephone 200. The telephone 200 includes a housing 201 with a display screen 202. The housing 201 includes an instruction pad 222 that includes a plurality of hard keys or buttons 203 that enable a user to enter alphanumeric data for “contactless” telecommunications via a transceiver (not shown) operatively coupled to an antenna 204. The telephone 200 includes a power ON or talk button 205 and, in one embodiment, may include a button 206 designated for example only by the letter “P” to represent a button designated for payment input and authorization functions. The telephone 200 may contain programmed instructions such that the button 206 may be depressed in conjunction with one or more of the other buttons 203, e.g., the “1” button or the “2” button, etc., to implement payment instructions. The mobile device 12′ includes other electronic devices having telecommunications capability such as a personal digital assistant (PDA) that has an instruction pad and a transceiver.

The mobile device 12′ may also be an electronic device having both telecommunications capability and also image capture capability such as a mobile or cellular telephone having photographic image capture capability, an electronic microscope, a CAT scanner, X-ray camera, or other medical device; a security camera; a badge reader; a fingerprint, retina, or other biometric reader; a currency reader or counterfeit detector; a medical or other diagnostic machine that outputs graphs, etc.

The payment vehicle 15 is a physical entity, for example, a contactless device such as an RFID (radiofrequency identification) tag or label having a self-contained transponder or transmitter or a smart card, an IrDA port, and/or code symbology such as a bar code displayed on a screen of the mobile device 12′, e.g., on screen 202 of telephone 200. The payment vehicle 15 stores machine readable data representing a financial account having an account number with which funds are associated with respect to a user identification for one or more individuals or organizations. For example, the payment vehicle 15 may represent a credit card account, a debit card account, or an electronic deposit account for which funds are pre-paid, e.g., Pay-Pal™. User identification data may be included with the data associated with the payment vehicle 15 or the user identification data may be stored on a separate contactless device as described above.

The print job is authorized by determining if the funds credited to or associated with the payment vehicle 15 are greater than or equal to the cost of the print job, e.g., an available balance of a credit card account or debit card account or a pre-paid deposit account associated with the payment vehicle 15 is greater than the cost of the print job being requested, thereby validating the payment vehicle 15. The print job may also be authorized by comparing the received user identification to listings of pre-authorized users or customers in a “look up” table and determining if the received user identification matches one of the pre-authorized customers and if a match is determined, authorizing the print job. Once the payment vehicle 15 is validated, the print job is completed with credit applied for any print job rejects, the processor 62 receives electronic funds from the payment processor 72 and deducts at least a portion of the electronic funds and directs the portion of the electronic funds to a system proprietor account 66 and transmits the remaining portion of the electronic funds to at least one external account 68. The system proprietor account 66 is associated with a provider of the print job payment service and/or owner of intellectual property rights associated with the print job payment service. The portion of the electronic funds directed to the system proprietor account may 66 be in the form of a transaction fee for the print job imposed by the system proprietor. The at least one external account 68 may include an account of the operator of the document machine 10 (or 10′), an account of the operator of the associated network 16, and an account of a telecommunications service provider, such as a cellular telecommunications service provider.

The interface module 18 interfaces with the mobile device 12′ for receiving at least one of a user identification and a payment vehicle 15 and transmitting the same to the control board 32. The control board 32 subsequently transmits the user identification and/or payment vehicle 15 to the processor 62 of the remote central station 60. As explained above,′ via the IR/RF transceiver 40 for receiving the print job from the mobile device 12′. Alternatively, the print job may originate from a source other than the mobile device 12′, e.g., from the scanner 38. In this alternate method of receiving the print job, the identification and/or payment vehicle 15 residing in the mobile device 12′ may be used to effect payment for the print job.

Those skilled in the art will recognize that the mobile device 12′ may also be a hard-wired telephone, including a telephone that can be plugged into a jack, or a mobile handset in communication with a hard-wired base station. The embodiments are not limited in this context.

FIGS. 7-8 illustrate an alternate embodiment of a system for effecting payment for a print job in accordance with the present disclosure. More particularly, system 52 is in all respects identical to system 50 described above with respect to FIGS. 4-6 except that the mobile device 12′, e.g., telephone 200, communicates with the processor 62 of the remote central station 60 via interface module 18 thereby bypassing the document machine 10 and the control board 32. The processor 62 of the remote central station 60 interfaces directly with the control board 32 of the document machine 10 via network 16. The security arrangement 42 checks for an identification code within a signal received from the mobile device 12′ prior to establishing communications with the process 62. The remote central station 60 authorizes the print job and effects payment of the print job if it is determined that there are sufficient funds to effect payment as described below. As described above with respect to FIG. 5, the mobile device 12′ can be a cellular phone, e.g., telephone 200, which can communicate with the processor 62 via the IR/RF transceiver 40 and the security arrangement 42. With the arrangement shown in FIG. 7, security information of the user, e.g., user identification and payment vehicle information, is not received by or stored in the control board 32 of the document machine 10.

In another embodiment illustrated in FIG. 7, the interface module 18 may be bypassed or removed so that the mobile device 12′ contactlessly couples to an external processor 82 via communication path 80. The external processor 82 also communicates with the processor 62 of the remote central station 60 via communication path 84. The external processor 82 and the remote central station processor 62 interact to verify identification of the user requesting a print job and validate a payment vehicle 15′. As opposed to payment vehicle 15 illustrated in FIG. 7 which is a physical entity that stores machine readable data, payment vehicle 15′ is electronic data stored in the external processor 82 or in another processor in, or in a data base in, direct communication with the external processor 82. The payment vehicle 15′ may be a telecommunications account stored and managed by the external processor 82. The user of the mobile device 12′, e.g., telephone 200, may use the mobile device 12′ to text message, via path 80, to the telecommunications account stored and managed by the external processor 82, e.g., to communicate the number of prints required and the cost of each print of the print job, or to communicate an amount of credit to be deducted for payment of the print job. In still another embodiment, a user may use the mobile device 12′ to call, via the path 80, a special pre-payment telephone number, with the call being received and processed by the external processor 82, to enter the parameters of a print job such as a number of prints, e.g., 12 prints or size A4 as illustrated in display 202, or the size of the prints requested on a Web GUI (graphical user interface), before the print job is processed. Alternatively, the user of the mobile device 12′ may initiate a voice call to a special toll number (such as a 900 number in the United States) to communicate with the external processor 82, wherein the external processor 82 may be controlled by a telecommunications provider or other service provider and the telecommunications provider imposes a charge, which may be on behalf of the other service provider, for the print job in a bill or invoice sent to the user, usually on a periodic basis.

Alternatively, the electronic data of payment vehicle 15′ may represent a financial account having an account number with which funds are associated with respect to a user identification for one or more individuals or organizations. In a similar manner to payment vehicle 15, payment vehicle 15′ may represent a credit card account, a debit card account, or an electronic deposit account for which funds are pre-paid, e.g., Pay-Pal™, as described above. User identification data may be included with the data associated with the payment vehicle 15′ or the user identification data may be stored in a separate electronic data file associated with the financial account.

The external processor 82 verifies the user identification and validates the payment vehicle 15′. The remote central station processor 62 transmits to the external processor 82 the cost of the print job being requested and the external processor 82 signals to the remote central station 60 whether the funds credited to or associated with the payment vehicle 15′ are greater than or equal to the cost of the print job, e.g., an available balance of a credit card account or debit card account or a pre-paid deposit account associated with the payment vehicle 15 is greater than the cost of the print job being requested, thereby validating the payment vehicle 15.

Once the external processor 82 verifies the user identification and processes payment for the print job to the central station 60, the remote central station processor 62 authorizes the print job and the print job is performed in the same manner as explained above wherein the processor 62 of the remote central station 60 interacts with the central control board 32 via the network 16 to process the print job.

In a similar manner as with respect to payment vehicle 15, the remote central station processor 62 authorizes the print job by interacting with the external processor 82. The external processor 82 determines if the funds credited to or associated with the payment vehicle 15′ are greater than or equal to the cost of the print job as applicable in view of the discussion above regarding special toll numbers. For example, the external processor 82 verifies whether an available balance of a credit card account or debit card account or a pre-paid deposit account associated with the payment vehicle 15′ is greater than the cost of the print job being requested, thereby validating the payment vehicle 15′. The external processor may authorize the print job also by comparing the received user identification to listings of pre-authorized users or customers in a “look up” table and determining if the received user identification matches one of the pre-authorized customers and if a match is determined, authorizing the print job.

Alternatively, the external processor 82 and the payment processor 72 are the same processor so that the mobile device 12′ communicates directly with the payment processor 72 via communication path 86 shown in FIG. 6. Following communication between the mobile device 12′ and the payment processor 72, the remote central station processor 62 determines whether to authorize the print job and, if yes, the amount of funds to deduct from the financial account associated with the payment vehicle 15 as described above.

Whether the mobile device 12′ communicates with the remote central station processor 62 via the external processor 82 or via the payment processor 72, the mobile device 12′ may still download a print job to the document machine 10 via the interface module 18, as described above, or request a print job from a source other than the mobile device, e.g., a hard copy print job to be scanned by the scanner 38 or a print job downloaded from a memory device to a USB (universal serial bus) port at the UI 36.

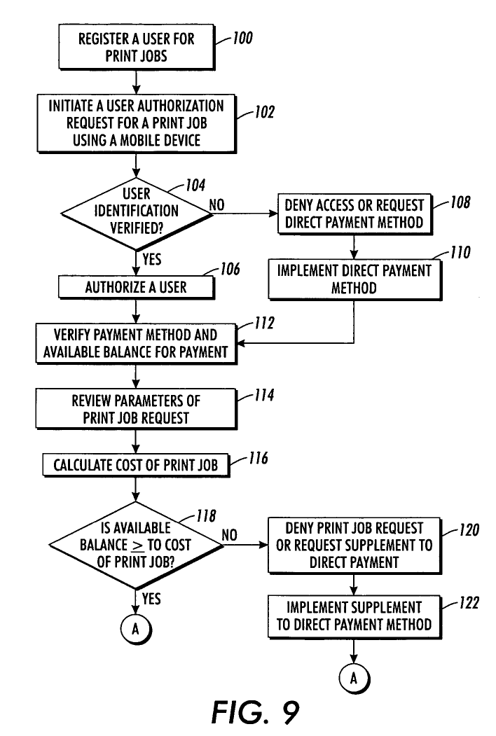

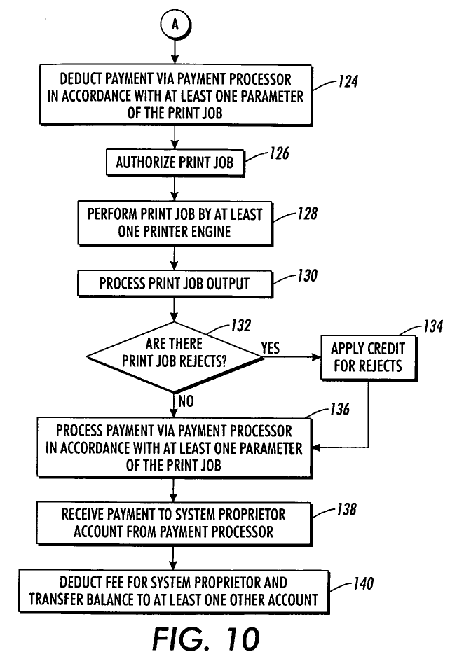

Referring to FIGS. 9-10, there is disclosed a method for effecting payment for a print job. More particularly the method for effecting payment for a print job may include a step 100 of registering a user for print jobs using document machine 10 (or 10′). Step 100 may be implemented by having a list of authorized users and their corresponding payment vehicles stored in a customer database such as customer data base 64 in the remote central station 60 (see FIGS. 6 and 8). Alternatively, step 100 may be implemented at the time of a print job request as registering a user as an “on-demand” user and determines a payment vehicle associated with the “on-demand” user.

Step 102 includes initiating a user authorization request for a print job using a mobile device by interfacing contactlessly with a document machine, e.g., document machine 10, via the mobile device 12′ (see FIGS. 4 and 6). As described with respect to systems 50 and 52, the document machine 10 includes the central control board 32 with which the mobile device 12 may interface contactlessly.

Step 104 includes a decision step of asking if the user identification has been verified. If YES, step 106 is implemented of authorizing the user. If NO, step 108 is implemented of denying access to the user or requesting a direct payment method, e.g., payment from a telecommunications account or a credit or debit card or other method as described above with respect to FIG. 6. In step 110, the user may implement a direct payment method.

Step 112 includes verifying the payment method and the available balance for payment. Step 114 includes reviewing the parameters of the print job request, e.g., number of prints, size of prints, color of prints, and other parameters known to or conceivable by those skilled in the art. Step 116 includes calculating the cost of the print job.

Step 118 includes a decision step of asking if the available balance of the payment method greater than or equal to the cost of the print job. If NO, step 120 is implemented of denying the print job request or requesting a supplement to the direct payment method, e.g., the user increases the balance available from the payment method by implementing step 122 of implementing a supplement to the direct payment method. If YES, indicating that the balance available is sufficient, or upon implementation of step 122, step 124 is implemented of deducting payment for the print job via a payment processor, e.g., payment processor 72.

Upon implementing the step 124 of deducting the payment for the print job, step 126 is implemented of authorizing the print job and step 128 is implemented of performing the print job by at least one print engine, e.g., print engine 30 in FIGS. 4 and 6. Step 130 is implemented of processing the print job output. As mentioned above, the print job output may include a hard copy print out of papers, documents, drawings, or photographs or scan-to-file, facsimile, or email.

Once step 130 is implemented of processing the print job output, decision step 132 includes a decision step of determining if there are any rejects in the print job. If YES, step 134 is implemented of applying a credit for the rejects. Once step 134 is implemented, or if NO, indicating there are no rejects, step 136 is implemented of processing the payment via a payment processor, e.g., payment processor 72 in FIGS. 4 and 6, or external processor 82 in FIG. 6, in accordance with at least one parameter of the print job, as mentioned above.

Step 138 includes receiving payment to a system proprietor account, e.g., system proprietor account 66 in FIGS. 5 and 7. Step 140 includes deducting a fee for the system proprietor and transferring the balance to at least one other account, e.g., one of the external accounts 68 in FIGS. 5 and 7.

The print job may be received by the document machine 10 via the mobile device 12, e.g., the print job resides in a memory in the mobile device, e.g., the mobile device is a both a cellular telephone and a digital camera from which the print job may originate.

The various processors described herein execute programmable instructions stored therein for performing their various functions also described herein.

It will be appreciated that variations of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

1. A system for effecting payment for a print job comprising:
a mobile device interfacing with a document machine having a print engine; and
a processor in communication with the mobile device, the processor configured to authorize a print job and effect payment for the print job.

2. A system for effecting payment for a print job according to claim 1, wherein the mobile device interfaces contactlessly with the document machine.

3. A system for effecting payment for a print job according to claim 1, wherein the mobile device is selected from the group consisting of a telephone; a personal digital assistant (PDA); a digital camera; an electronic microscope; a CAT scanner; an X-ray camera; a security camera; a badge reader; a biometric reader; a currency reader, a counterfeit detector; and a diagnostic machine that outputs graphs.

4. A system for effecting payment for a print job according to claim 1, wherein the processor is disposed at a remote central station interfacing with the document machine, the remote central station configured to effect payment via a network in communication with the document machine and with the processor.

5. A system for effecting payment for a print job according to claim 4, wherein the mobile device communicates with the remote central station via an external processor, the external processor and the processor in communication with the mobile device communicating therebetween to authorize the print job and effect payment for the print job.

6. A system for effecting payment for a print job according to claim 4, wherein
the document machine further comprises:
a control board; and
an interface module in communication with the control board, the interface module configured to interface with the mobile device to download at least one of a user identification and a payment vehicle to the control board for at least one of authorizing a print job and effecting the payment for the print job.

7. A system for effecting payment for a print job according to claim 6, wherein the interface module is configured to contactlessly interface with the mobile device to enable downloading of the print job to the control board.

8. A system for effecting payment for a print job according to claim 5, wherein the document machine further comprises a scanner, and wherein the scanner is configured to enable downloading of a print job to the control board.

9. A system for effecting payment for a print job according to claim 1, wherein the processor is disposed at a remote central station interfacing with the document machine, the remote central station configured to authorize the print job and to effect payment of the print job via a network in communication with the mobile device and with the processor.

10. A system for effecting payment for a print job according to claim 9, wherein
the document machine further comprises:
a control board; and
an interface module in communication with the control board, wherein the interface module is configured to contactlessly interface with the mobile device to enable authorizing downloading a print job to the control board.

11. A system for effecting payment for a print job according to claim 10, wherein the interface module enables downloading a print job from the mobile device.

12. A system for effecting payment for a print job according to claim 9, wherein the document machine further comprises:
a processor; and
a scanner, and wherein the scanner is configured to enable downloading to the control board of a print job scanned by the scanner.

13. A system for effecting payment for a print job according to claim 12, wherein the print job is a print job scanned by the scanner.

14. A remote central station for payment of a print job, the remote central station comprising:
means for communicating via a network with at least one mobile device and a document machine having a print engine;
a customer database storing a plurality of customer records, each customer record identified by a user identification;
a processor for receiving at least one user identification via the means for communicating and accessing a customer record for identifying a payment vehicle corresponding to the received user identification; and
means for communicating with a payment processor for transmitting payment authorization thereto for effecting payment using the identified payment vehicle.

15. A remote central station for payment of a print job according to claim 14,
wherein the remote central station processor receives payment from the payment processor and deducts at least a portion of the payment and directs the at least a portion of the payment to a system proprietor account and transmits the remaining portion to at least one external account.

16. A method of effecting payment for a print job comprising the step of interfacing with a document machine via a mobile device.

17. A method of effecting payment for a print job according to claim 16, wherein the step of interfacing is performed contactlessly.

18. A method of effecting payment for a print job according to claim 16, further comprising the steps of:
receiving a print job via the mobile device;
verifying at least one of the identity of the user and the validity of a payment vehicle, and wherein if at least one of the identification is verified and the payment vehicle is validated,
authorizing the print job;
performing the print job; and
deducting payment via a payment processor in accordance with at least one parameter of the print job.

19. A method of effecting payment for a print job according to claim 18, further comprising the steps of:
receiving the payment to a system proprietor account from the payment processor; and
deducting from the payment a fee for the system proprietor.

20. A method of effecting payment for a print job according to claim 19, further comprising the step of transferring the balance of the payment to at least one other account.

21. A method of effecting payment for a print job according to claim 18, wherein prior to performing the step of implementing the print job, performing the steps of:
reviewing at least one parameter of the print job requested by the user;
calculating cost of the print job; and
determining if the available balance is greater than or equal to the cost of the print job.

22. A method of effecting payment for a print job according to claim 21, wherein if the available balance is not greater than or equal to the cost of the print job, the steps of denying the print job request or requesting a supplement to the direct payment are performed.

23. A method of effecting payment for a print job according to claim 18, wherein the user identity is verified by accessing a plurality of records in a customer database.

24. A method of effecting payment for a print job according to claim 18, wherein the step of performing the print job is performed by at least one print engine and the method further comprises the step of processing the print job output of the at least one print engine.

25. A method of effecting payment for a print job according to claim 24, further comprising the steps of determining if at least one reject exists amongst output of the print job,
wherein if yes, the step of applying a credit for the at least one reject to the cost of the print job is performed, and
wherein if no, the step of processing a payment in accordance with at least one parameter of the print job via a payment processor is performed.
